(19) United States
(12) Patent Application Publication
(10) Pub. No.: US 2005/0109222 A1
(43) Pub. Date: May 26, 2005

(54) Cookie handling device and method of use

(76) Inventor: Weston Swenson, Payson, UT (US)

Correspondence Address: RANDALL B. BATEMAN;BATEMAN IP LAW GROUP, 8 EAST BROADWAY, SUITE 550, PO BOX 1319, SALT LAKE CITY, UT, 84110, US

(21) Appl. No.: 10/957,425

(22) Filed: Sep. 30, 2004

Related U.S. Application Data
(60) Provisional application No. 60/507,756, filed on Oct. 1, 2003.

(51) Int. Cl. A23L 1/216

(52) U.S. Cl. 99/494

(57) ABSTRACT

A cookie-dunking apparatus is inserted partially into a cookie and the cookie-dunking apparatus may then be used to dunk the cookie into a liquid, such as milk, without getting the liquid or softened cookie on the dunker's fingers.

### RELATED APPLICATIONS

The present application claims the benefit of U.S. Provisional Application Ser. No. 60/507,756 filed Oct. 1, 2003.

### BACKGROUND OF THE INVENTION

1. The Field of the Invention

The present invention relates to a device for handling cookies and a method of use thereof. More particularly, the present invention relates to a device and method by which cookies may be dunked into milk or other liquids without the user's hand having to contact the liquid.

2. State of the Art

Many people enjoy eating sweets, and in particular cookies. Each year in the United States alone many billions of dollars worth of cookies are consumed by the public. While many people enjoy eating cookies straight out of the box or package, there is also a large group who enjoys dipping or dunking cookies into some other substance. One of the most common of these substances is milk. Many people will take a cookie from its packaging and let it soak in milk for some period of time to absorb the milk's flavor. The cookie is then eaten.

While dunking a cookie in milk is enjoyable for these people, there are drawbacks. First, the person dunking the cookie must either keep part of the cookie out of the milk or must stick his or her hand into the milk while dunking. Many people prefer not to get the milk on their fingers, as such would require cleaning one's hands before doing anything else. Additionally, when a cookie is placed in milk it tends to become soggy. If the person places their hand in the milk, it is common for part of the cookie to stick to the user's hands, again requiring the hands to be cleaned.

While some people may attempt to use tong-like devices to hold the cookie when dunking, the effect of the milk on the cookie causes the cookie to become soft. Thus, it is not uncommon for a cookie to break apart under the force of the tongs. The person is then left with a cookie floating in the milk which is either thrown away or must be retrieved by some other mechanism. In the process of retrieving the cookie, the person may spill the milk and cookie parts on themselves.

Thus, there is a need for an improved apparatus and method for dipping or dunking a cookie in milk or other liquids. Such a device should be generally inexpensive and easy to use.

### SUMMARY OF THE INVENTION

It is an object of the present invention to provide an improved method for dipping or dunking a cookie in a liquid.

It is another object of the invention to provide such a device which is generally inexpensive and easy to use.

The above and other objects of the invention are accomplished in a cookie-dunking apparatus having a handle and at least one prong for insertion into the cookie. By inserting a prong into the cookie, the cookie can be held to be dunked. Additionally, because the prong engages the interior of the cookie, the likelihood that the softened exterior created by the milk would cause the cookie to fall off the cookie-dunking apparatus is significantly reduced.

In accordance with one aspect of the present invention, the cookie-dunking apparatus includes a plurality of prongs which extend into the cookie to hold the cookie while it is being dipped or dunked. The prongs help to stabilize the cookie while it is being dunked and eaten.

In accordance with another aspect of the invention, the handle of the cookie-dunking apparatus can be configured so as to provide advertising for the cookie manufacturer or for other products. Additionally, the handle may be formed into a cartoon character or other fanciful shape.

In accordance with yet another aspect of the present invention, the method includes inserting the cookie-dunking apparatus so that the prongs extend into a center portion of the cookie to thereby hold the cookie while it is being dunked.

In accordance with yet another aspect of the invention, the cookie selected is a cookie having a creme filling and the method includes inserting the prongs of the cookie-dunking apparatus into the creme filling and then dipping or dunking the cookie in a liquid, preferably milk.

In accordance with another aspect of the invention, the cookie selected might not have a creme filling and the method includes inserting the prongs into a center portion of the cookie and then dipping or dunking the cookie in a liquid.

In accordance with yet another aspect of the invention, the prongs are configured so as to adequately engage the interior part of a cookie, but of sufficiently minimal size so as to minimize destruction on the filling, etc., in the cookie.

In accordance with yet another aspect of the present invention, the material used to construct the cookie-dunking apparatus may be selected such that the cookie-dunking apparatus floats in milk or other liquids.

In accordance with yet another aspect of the invention, the cookie-dunking apparatus can be formed from a variety of materials including, but not limited to metal, plastic and wood.

In accordance with still yet another aspect of the present invention, the cookie-dunking apparatus can be used as an advertising device. The apparatus can be shaped similar to one part of a sandwich-type cookie and included in a package of the cookies. Once the cookies have been eaten, the cookie-dunking apparatus remains as advertising for the cookies and can be used again as desired.

### BRIEF DESCRIPTION OF THE DRAWINGS

Various embodiments of the present invention are shown and described in reference to the drawings. It will be appreciated that the embodiments shown are illustrative but not limiting to the scope of the invention, which is set forth in the claims.

FIG. 1 shows a perspective view of a cookie-dunking apparatus in accordance with the principles of the present invention;

FIG. 1a shows a side view of the cookie-dunking apparatus of FIG. 1;

FIG. 1b shows an end view of the cooking-dunking apparatus of FIG. 1;

FIG. 1c shows an illustration of the cooking-dunking apparatus being used to dunk a cookie;

FIG. 2 shows an alternate embodiment of a cookie-dunking apparatus made in accordance with principles of the present invention;

FIG. 2a shows a side view of the cookie-dunking apparatus of FIG. 2;

FIG. 2b shows an end view of the cooking-dunking apparatus of FIG. 2;

FIG. 2c shows an illustration of the cooking-dunking apparatus being used to dunk a cookie;

FIG. 3 shows another embodiment of a cookie-dunking apparatus made in accordance with principles of the present invention;

FIG. 4 shows yet another embodiment of a cookie-dunking apparatus in accordance with principles of the present invention;

FIG. 5 shows an embodiment of the cookie-dunking apparatus in use; and

FIG. 6 shows a flow chart of a cookie-dunking method in accordance with principles of the present invention.

### DETAILED DESCRIPTION

The drawings will now be discussed in reference to the numerals provided thereon so as to enable one skilled in the art to make and use the present invention. It will be appreciated that the drawings and description thereof are for explanatory purposes and are not intended to narrow the scope of the appended claims.

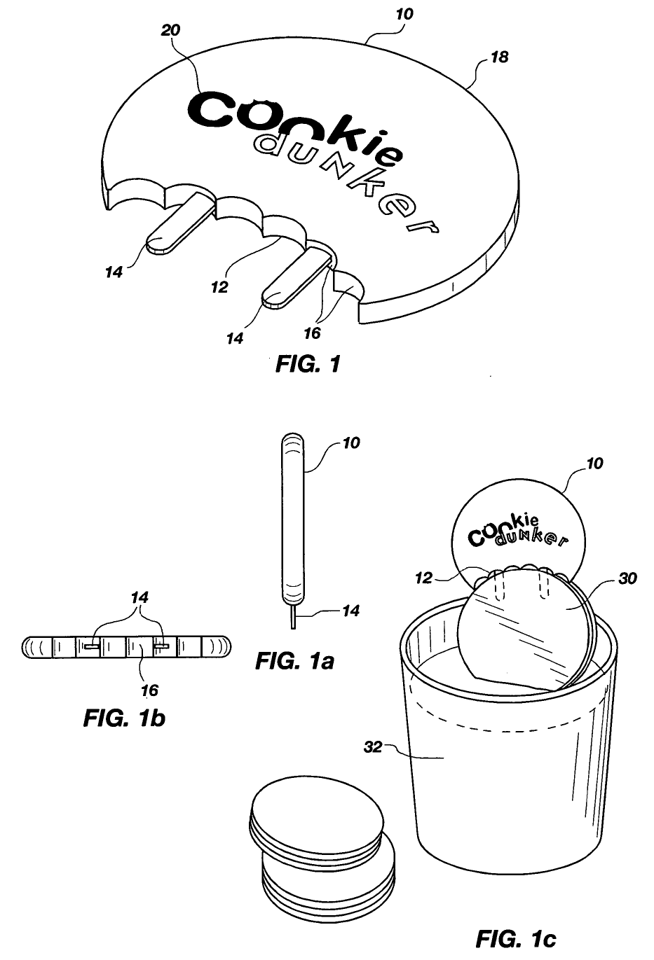

Referring now to FIG. 1, there is shown a perspective view of an embodiment of a cookie-dunking apparatus 10 made in accordance with the principles of the present invention. The cookie-dunking apparatus 10 is configured to be of such a size to be easily handled by both children and adults. In this embodiment, the cookie-dunking apparatus 10 is configured in a generally circular shape.

The cookie-dunking apparatus 10 has a concave recess 12 wherein two prongs 14 are attached are attached to the cookie-dunking apparatus 10. In particular, the recess 12 consists of multiple scallop shaped recesses 16 to simulate a bite. The prongs 14 are inserted into a cookie and hold the cookie securely to the cookie-dunking apparatus 10, nesting the cookie into the recess 12.

A logo 18 may be placed on the surface of the cookie-dunking apparatus 10, and may comprise any shape, logo, brand, or picture, desired. The edge 20 of the cookie-dunking apparatus 10 is textured to provide a better gripping surface and provide r a more attractive look.

Turning now to FIG. 1a and FIG. 1b, a side view and end view of the cookie-dunking apparatus 10 are shown. In the present embodiment, the cookie-dunking apparatus 10 is of a similar thickness as a cookie or of one layer of a multi-layer or sandwich cookie. It is apparent from this view that the prongs 14 are sufficiently thin to be inserted into a cookie. The prongs 14 are also thin enough to be inserted into the creme filling of a sandwich cookie.

Referring to FIG. 1c, a cookie-dunking apparatus 10 is used to dunk a cookie 30. The cookie 30 nests into the recess 12 of the cookie-dunking apparatus 10 and is held securely. The cookie 30 is then inserted into a liquid 32, typically milk, and allowed to remain in the liquid as desired. The cookie 30 is then removed from the liquid and eaten. The cookie-dunking apparatus 10 thus allows a person to dunk and eat a cookie without getting his or her fingers messy. Furthermore, the cookie can be left in long enough, if desired, that the outer layers of the cookie dissolve sufficiently to leave only the cream filling on the cookie-dunking apparatus.

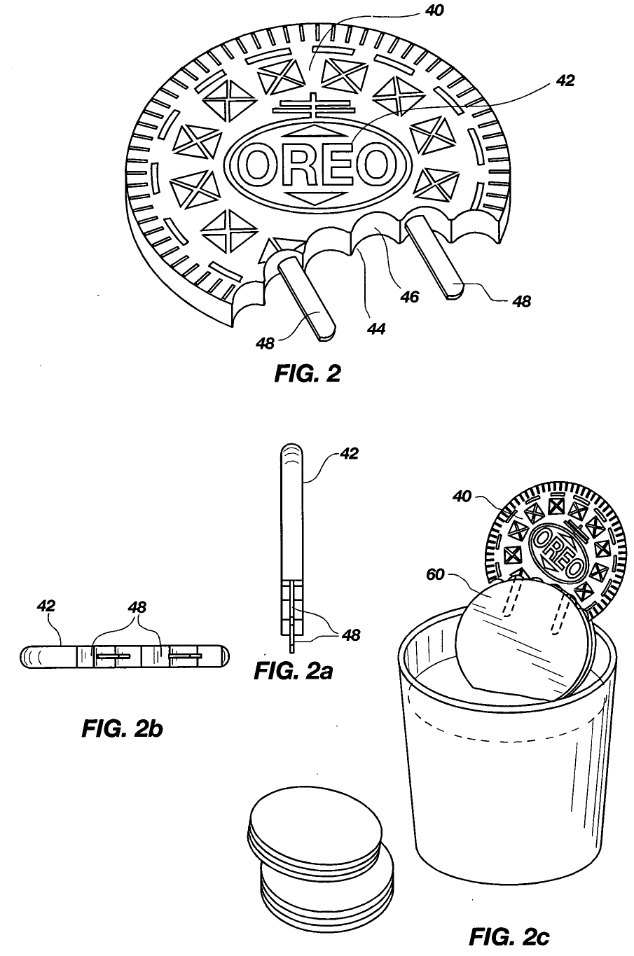

Turning now to FIG. 2, another embodiment of a cookie-dunking apparatus 40 is shown. This embodiment of a cookie-dunking apparatus 40 is made to resemble an OREO™ cookie, or other sandwich-type cookie. Accordingly, the face 42 of the cookie-dunking apparatus 40 is formed with the surface details of an OREO cookie. The cookie-dunking apparatus 40 may be formed of a dark brown material, such as plastic, to further resemble an OREO cookie (or any other sandwich-type cookie).

The cookie-dunking apparatus 40 has a concave recess 44 which is formed of multiple scallop-shaped recesses 46 and shaped to resemble a bite which has been taken from a cookie. Two prongs 48 are attached to the cookie-dunking apparatus 40 at the scalloped edge 46 of the recess 44. The prongs 48 are sufficiently long and thin to be easily inserted into a cookie, and as intended for this embodiment, into the creme filling of an OREO sandwich cookie.

Turning now to FIG. 2a and FIG. 2b, a side and end view, respectively, are shown. These views show the prongs 48 in relation to the cookie-dunking apparatus 40.

Referring now to FIG. 2c, the cookie-dunking apparatus 40 of FIG. 2 is shown while used to dunk a cookie 60. The cookie 60 nests into the recess 44 of the cookie-dunking apparatus 40 and is held securely. The cookie 60 is then inserted into a liquid 62, typically milk, and allowed to remain in the liquid as desired. The cookie 60 is then removed from the liquid and eaten. The cookie-dunking apparatus 40 thus allows a person to dunk and eat a cookie without getting his or her fingers messy.

FIG. 2c further illustrates one of the aspects of the present invention by showing the use of a cookie-dunking apparatus 40 which is specifically designed to resemble a certain cookie and could be used as a promotional item for that cookie. In this situation, the cookie-dunking apparatus 40 is designed to resemble an OREO cookie and may be included in packages of OREO cookies as a promotional item. The cookie-dunking apparatus 40 might then be used to consume the OREO cookie 60. The cookie-dunking apparatus 40 thus becomes valuable to cookie manufacturers as a novelty or promotional item.

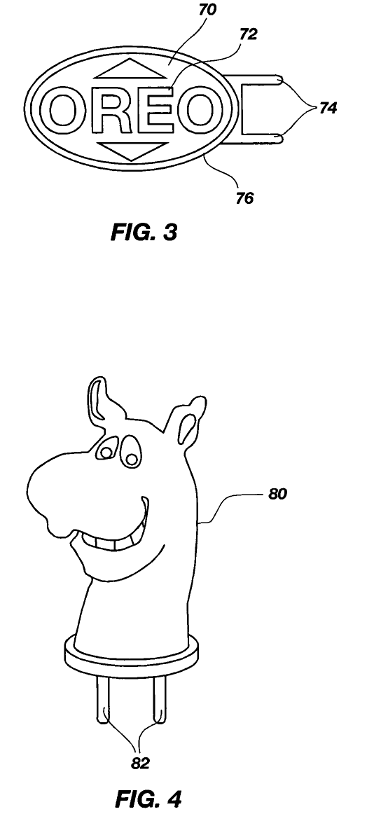

Referring now to FIG. 3, another embodiment of the cookie-dunking apparatus 70 is shown. According to one aspect of the present invention, the cookie-dunking apparatus 70 may be configured to resemble the logo, trademark, or other symbol which represents a particular cookie manufacturer. In this embodiment, the surface 72 of the cookie-dunking apparatus 70 is designed to resemble an OREO logo which may be found on the OREO cookie or in related advertising material. The cookie-dunking apparatus 70 has at least one prong 74 attached to the edge 76 of the cookie-dunking apparatus 70. The prongs 74 of the cookie-dunking apparatus 70 are inserted into a cookie to dunk the cookie in milk, or another desired liquid.

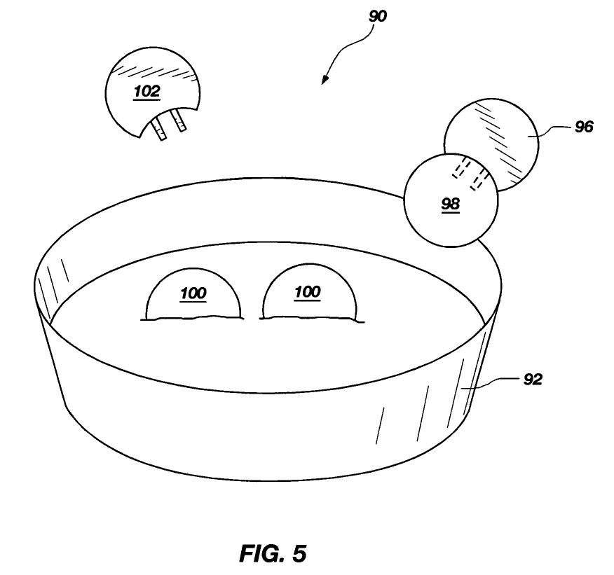

Turning now to FIG. 4, another embodiment of the cookie-dunking apparatus 80 is shown. According to an aspect of the invention, the cookie-dunking apparatus 80 is made to resemble a children's cartoon character. Accordingly, the cookie-dunking apparatus 80 may be made to resemble any type of fanciful character including, but not limited to, children's cartoon characters, movie characters, team mascots, or cookie mascots. The cookie-dunking apparatus 80 has at least one prong 82 attached to the cookie-dunking apparatus 80.

Referring now to FIG. 5, a number of cookie-dunking apparatuses, indicated generally at 90, are shown in use. Each cookie-dunking apparatus 90 is used to place cookies in a bowl 92 of milk 94. One cookie-dunking apparatus 96 is used to dunk a cookie 98 into the milk 94. Another cookie-dunking apparatus 100 has been placed and left in the milk 94 to allow the milk 94 to be absorbed into a cookie.

The cookie-dunking apparatus 100 may be formed of a material which has a lower density than water or milk. A cookie-dunking apparatus 100 that is formed of such a material will float in milk 94 and if designed accordingly, could maintain a cookie underneath the surface of the milk 94 while the cookie-dunking apparatus 100 remains substantially above the surface of the milk 94.

A person could thus leave a cookie soaking in the milk 94 for a period of time and retrieve the cookie without placing his or her fingers in the milk 94. Additionally, a person could use multiple floating cookie-dunking apparatus 100 to suspend multiple cookies in the milk 94 simultaneously. Another advantage of a cookie-dunking apparatus 102 made from a material that has a lower density than water or milk is that the cookie-dunking apparatus 102 will float if dropped inadvertently into the milk 94. The dropped cookie-dunking apparatus 102 may then be retrieved from the milk 94 with only a minimal amount of milk contacting the person's fingers.

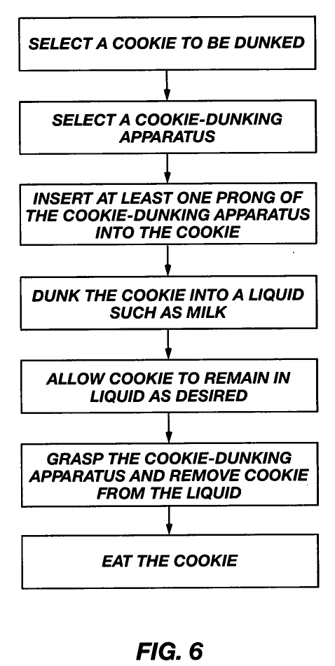

Turning to FIG. 6, a flowchart of a cookie-dunking method in accordance with an aspect of the present invention is shown. Typically, a person desiring to dunk a cookie might first select a cookie to be dunked. The person then might select a cookie-dunking apparatus.

The cookie-dunking apparatus selected might depend on several factors. For a creme filled cookie, a cookie-dunking apparatus with two thin prongs might be selected. For a cookie without a creme filling, a cookie-dunking apparatus with thicker prongs, or a cookie-dunking apparatus constructed form metal might be selected so that the prongs are not broken while inserting the prongs into the cookie.

Additionally, a child may desire a cookie-dunking apparatus designed to resemble their favorite cartoon character might be selected. Likewise a person might select a cookie-dunking apparatus designed to resemble the logo for a favorite sports team, etc.

After selecting a cookie-dunking apparatus, a person would then typically insert the prongs of the cookie-dunking apparatus into the cookie. The cookie might then be lowered into the desired dunking liquid, such as milk. The cookie may be left in the liquid as long as is necessary to allow the cookie to absorb the desired amount of liquid.

If a cookie-dunking apparatus that floats in the liquid is selected, the person may release the cookie-dunking apparatus and allow the buoyancy of the cookie-dunking apparatus to suspend the cookie in the liquid. The person might then use multiple cookie-dunking apparatus and dunk multiple cookies in the liquid at the same time.

Once the cookies have remained in the liquid for sufficient time to absorb the desired amount of liquid, the person may grasp the cookie-dunking apparatus to remove the cookie from the liquid and eat the cookie.

Those skilled in the art will appreciate that the cookie-dunking apparatus as disclosed herein has dual uses. In addition to its utility with cookies to be dunked, it also can serves as an advertising method. By shaping the apparatus like a trademark or the shape of a particular type of cookie, the cookie dunking apparatus can be configured in such as way as a reminder to consumers of the cookie.

The cookie-dunking apparatus can be packaged in a pack of cookies for use in dunking. Once all the cookies are eaten, the cookie-dunking apparatus may be kept for use with other cookies. All the while, the cookie-dunking apparatus serves as a reminder of the cookie brand, subtly encouraging the consumer to purchase more of the cookies.

Thus, there is disclosed an improved cookie-dunking apparatus. Those skilled in the art will appreciate numerous modifications which can be made without departing from the scope and spirit of the invention. The appended claims are intended to cover such modifications.

1. A cookie-dunking device comprising:
a handle configured generally in the shape of a cookie; and
a plurality of prongs attached to the handle.

2. The cookie-dunking device of claim 1, wherein the handle is impressed with the shape of a cookie.

3. The cookie-dunking device according to claim 1, wherein the handle has a generally arcuate recess formed therein.

4. The cookie-dunking device according to claim 3, wherein the generally arcuate recess is scalloped.

5. The cookie-dunking device according to claim 3, wherein the plurality of prongs are disposed in the recess.

6. A cookie-dunking device comprising:
a handle configured to resemble a cookie manufacturer's logo; and
a plurality of prongs attached to the handle.

7. The cookie-dunking device according to claim 6, wherein the handle is generally oval shaped.

8. The cookie-dunking device according to claim 6, wherein the handle and plurality of prongs are formed from a single piece of plastic.

9. A method of dunking cookies comprising:
selecting a cookie;
selecting a cookie-dunking device;
inserting the cookie-dunking device into the cookie; and
dunking the cookie into a liquid.

10. The method according to claim 9, wherein the cookie-dunking device comprises a circular handle with at least one prong attached to the handle and wherein the method comprises inserting the at least one prong into the cookie.

11. The method according to claim 9 wherein the handle has a recess and wherein the method comprises disposing a part of the cookie in the recess.

12. The method according to claim 11 wherein the recess further comprises a series of concave arcs resembling bite marks.

13. The method according to claim 9 wherein the cookie has a cream filling, and wherein the method comprises inserting the at least one prong into the cream filling.

14. The method according to claim 13 wherein the cookie-dunking device comprises a plurality of prongs and wherein the method comprises inserting the plurality of prongs into the cream filling.

15. The method according to claim 9, wherein the cookie-dunking device is configured to float in milk.

16. A cookie-dunking device comprising:
a handle; and
at least one prong configured to insertion into a central portion of a cookie; and
wherein the cookie-dunking device is configured to float.

17. A method for marketing a brand of cookies, the method comprising:
selecting a package of cookies; and
disposing a cookie-dunking apparatus in the package of cookies.

18. The method according to claim 17, wherein the method comprises selecting a cookie-dunking apparatus which is similar in appearance to the cookies.

19. The method according to claim 17, wherein the method comprises selecting a cookie-dunking apparatus which is shaped similar to a trademark associated with the cookies.

20. The method according to claim 17, wherein the method comprises selecting a cookie-dunking apparatus which is shaped as a cartoon character.
